(19) United States
(12) Patent Application Publication
(10) Pub. No.: US 2011/0106390 A1
(43) Pub. Date: May 5, 2011

(54) METHOD FOR OPERATING A DRIVE TRAIN OF A VEHICLE AND DEVICE FOR CARRYING OUT THE METHOD

(75) Inventors: Christian Post, Stuttgart (DE); Andreas Kirsch, Stuttgart (DE)

(73) Assignee: Robert Bosch GMBH, Stuttgart (DE)

(21) Appl. No.: 12/812,876

(22) PCT Filed: Nov. 11, 2008
(86) PCT No.: PCT/EP2008/065276

§ 371 Date: Jan. 18, 2011

(30) Foreign Application Priority Data
Jan. 14, 2008 (DE) 10 2008 004 209.9

(51) Int. Cl. B60K 28/16; G06F 19/00

(52) U.S. Cl. 701/84; 701/102

(57) ABSTRACT

A method for operating a drive train of a vehicle comprising an internal combustion engine (101) with an exhaust gas purification device (102) located in the exhaust gas line, characterized in that in predetermined operating states of the internal combustion engine (101) and/or of the vehicle a correction torque is imposed onto a desired torque (140) produced by an engine control unit in relation to said desired torque such that an output torque (110) is produced for a pre-determined time interval, the value of said output torque lying outside a low-load range.

The invention relates to a method for operating a drive train of a vehicle comprising an internal combustion engine and a device for carrying out the method according to the preambles of the claims 1 and 8.

The subject matter of the invention is a computer program as well as a computer program product with a program code, which is stored on a machine-readable carrier, for carrying out the invention.

### TECHNICAL FIELD

Exhaust gas aftertreatment systems as, for example, diesel particle filters (DPF) or NOx-storage catalytic converters are used to meet exhaust emission standards. Particles resulting from the combustion process are collected in the diesel particle filter. When the exhaust gas temperatures are high, the collected particles are burned off and the diesel particle filter is again emptied. This occurs however without additional interventions only during high load conditions. Measures for increasing the temperature, such as, for example, a selective degradation of the engine's level of efficiency by retarding the start of injection, afterinjections or a preheating of the intake air temperature, can furthermore be taken within a broad operating range in order to make a regeneration of the diesel particle filter possible. Said measures are however disadvantageous on account of the resulting increased fuel consumption and degradation of the comfort characteristics of the vehicle. When the load on the engine and the engine speed are too low, a regeneration of the diesel particle filter is impossible on account of the low exhaust gas temperature. This range represents a problem for the operational reliability of the diesel particle filter.

Up until now materials, which were not critical with respect to their maximum limit temperature which can arise during a regeneration of the particle filter when the vehicle is overrunning, have been used for diesel particles filters. Through the use of new cost effective filter materials, care must henceforward be taken that a maximum temperature is not exceeded, for example during overrun conditions. Beside other measures, low-load operating points must be avoided during the regeneration of the particle filter when the vehicle is overrunning. This is the case because an oxygen restricted regeneration operation can no longer be assured in this instance. Overrun conditions of the engine are understood to be an operating state of the vehicle, wherein the kinetic energy outputted to the internal combustion engine by the vehicle via the drive train is considerable. The vehicle drives the engine under these conditions, for example on a mountain pass descent with a gear engaged or a gear speed of an automatic transmission engaged. A method for the regeneration of a diesel particle filter emanates from the German patent DE 10 2005 003 628 A1. In this method a torque outputted or absorbed by an electric machine of a hybrid vehicle is imposed onto the torque requested by the engine control unit in relation to an operating state of the exhaust gas purification device. Said torque imposition is conducted in order to adjust an optimal operating state of the internal combustion engine by means of a coordinated activation of the internal combustion engine and the electric machine while maintaining the current performance requirement.

It is the aim of the invention to convey a method and a device for carrying out this method, which allow for the regeneration of a particle filter without the occurrence of low-load operating points during the regeneration of the particle filter when the vehicle is overrunning. In so doing, particle filters can also be used which only tolerate a limited maximum temperature.

### SUMMARY

### Advantages of the Invention

This aim is met by a method for operating a drive train of a vehicle comprising an internal combustion engine with the characteristics of claim 1 as well as by a device for carrying out the method with the characteristics of claim 7.

It is the basic idea of the invention that in predetermined operating states a correction torque is imposed onto a desired torque produced by an engine control unit in relation to said desired torque such that an output torque is produced for a predetermined time interval, the value of said output torque lying outside a low-load range. In other words, a correction torque is produced in relation to a desired torque, which, for example, is based on a driver request or on the request of a cruise control system, such that a critical range, in particular a low-load range, is passed through very quickly and has little disrupting effect.

Additional advantages, characteristics and embodiments of the method according to the invention are the subject matter of the sub-claims which refer back to claim 1.

The predetermined operating states of the internal combustion engine are thus, for example, characterized by the following conditions:
the engine rotational speed is less than a predetermined threshold,
a predetermined engine operating mode currently prevails,
in particular overrun conditions currently prevail.

Furthermore, the predetermined operating states of the internal combustion engine and/or the vehicle are characterized in a further embodiment of the invention by the following additional characteristics:
an external access of a control device, which controls the dynamics of vehicle movement, is not present—in particular an access of a traction control system, of an electronic control program, of an engine-drag torque control or of a transmission protection.

The determination of the correction torque preferably occurs mathematically in a control unit on the basis of the engine rotational speed and the desired torque. Beside the mathematical determination, a determination of the correction torque can also occur with the aid of an engine characteristic map, which represents the correlation between the correction torque and the engine rotational speed as well as the desired torque.

Provision is made according to an advantageous embodiment of the method for below a predetermined torque threshold the correction torque to be adjusted such that the output torque of the drive train corresponds to a value of 0 and for above the predetermined torque threshold the correction torque to be selected such that the output torque of the drive train assumes a constant value, which is slightly larger than a predetermined torque value characterizing the low-load operating point.

This embodiment assures that undesirable operating ranges of the internal combustion engine are quickly passed through.

The correction torque is adjusted as a result of variables characterizing the combustion processes of the internal combustion engine, in particular the injection time and/or the injection duration, being changed in such a way that the desired correction torque is produced.

The variables characterizing the combustion processes are selected in such a way that a correction torque is produced, whose temporal curve has a slope limit.

Moreover, the correction torque is only then produced if the correction torque is less than a predetermined threshold. Step changes in the torque are thereby avoided.

The device according to the invention for carrying out the method has an engine control unit designed for carrying out the method. The method itself can be implemented in this engine control unit by a corresponding circuit part. The method is however preferably implemented as a computer program in a computing device of the control unit. The computer program itself is advantageously stored on a computer program product, which the computing device can read. This is therefore especially advantageous because the method according to the invention can as a result be implemented merely by a change in the control functionality, i.e. for example by a pure software change in the engine control unit. Furthermore, existing engine control units can also be upgraded in this manner. The new particle filters described at the beginning of the application, which can only be used up to a maximum temperature, can also as a result be upgraded in existing motor vehicles.

### BRIEF DESCRIPTION OF THE DRAWINGS

Examples of embodiment and additional aspects and advantages of the invention are depicted in the drawings and explained in detail in the description below.

The following are shown:

FIG. 1 schematically a flow diagram of a method according to the invention and

FIG. 2 schematically torque versus time as it arises when applying the method according to the invention to a drive train of a vehicle.

### DETAILED DESCRIPTION

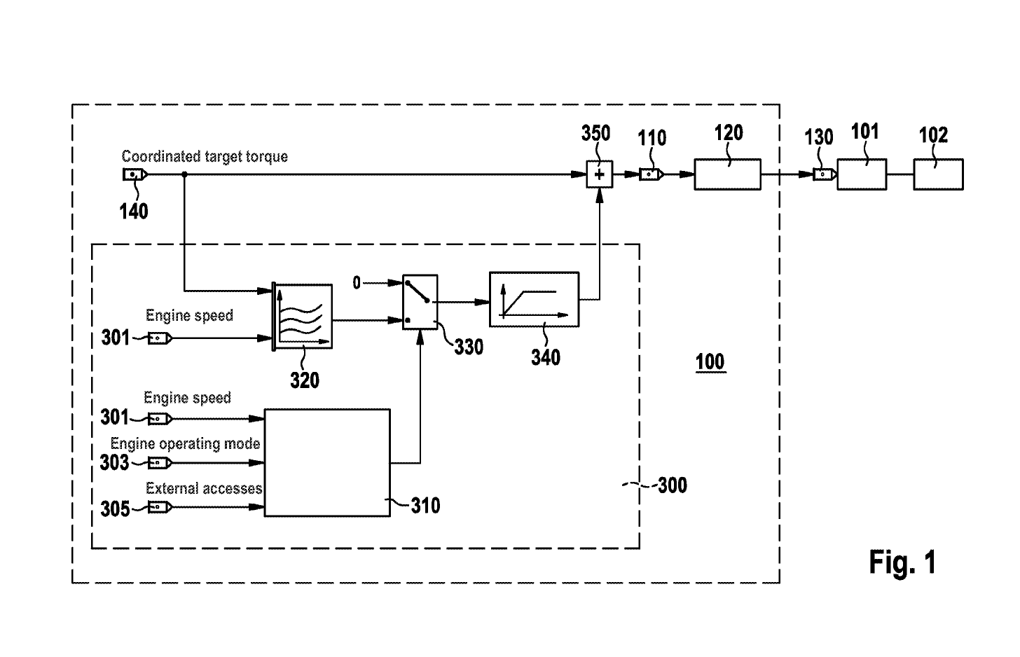

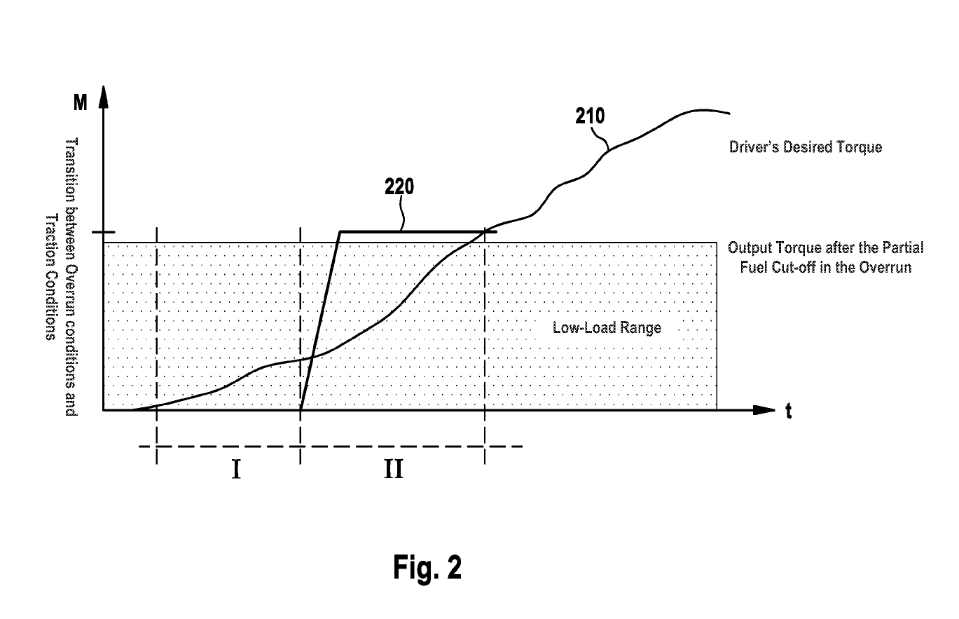

An example of embodiment of the method according to the invention is explained in detail below in connection with FIG. 1 and FIG. 2.

A conversion of the torque into, for example, an injected quantity 130 takes place in relation to a desired output torque 110 in a circuit device (in a step/circuit unit 120) of a control unit 100, in which the subsequently described method is implemented, for example, as a computer program or as a corresponding circuit. These procedural steps take place in all vehicles, in which a desired torque is adjusted by altering the variables characterizing the combustion processes.

Vehicles having diesel internal combustion engines 101 are provided today with so-called diesel particle filters (DPF) 102, which are disposed in the exhaust gas line of the internal combustion engine 101. These diesel particle filters have to be regenerated from time to time. Filter materials, which can only be operated up to a maximum limit temperature, are to be used in DPFs 102 of the new generation. Destruction of or damage to the DPF occurs at temperatures above this limit temperature.

Care must therefore be taken to assure that a maximum temperature is not exceeded during the regeneration process. For this reason, notably low-load operating points must be avoided during the regeneration of the particle filter when the vehicle is overrunning This is the case because an oxygen restricted regeneration can no longer be assured in this instance. An oxygen rich regeneration leads namely to a higher temperature and particularly to a temperature, which may cause damage to the DPF 102.

In this case, the term “overrun” refers to a condition of the vehicle, wherein the engine is driven by virtue of the kinetic energy of the vehicle. This, for example, would occur on a mountain pass descent with a gear engaged or with a gear speed of an automatic transmission engaged. The previously mentioned low-load operating points can occur under such driving conditions. In order to avoid such low-load operating points, provision is then made in the invention for a correction torque to be imposed onto a coordinated target torque, i.e. a desired torque 140. The determination of this correction torque takes place on the basis of the engine rotational speed 301, the engine operating mode 303 as well as on the basis of control variables 305, which characterize external accesses. In a first circuit unit of a circuit device 300 or in a first procedural step 310, a check is made to determine whether predetermined release conditions are satisfied. The calculation of the correction torque only then occurs if the following conditions are satisfied:
the engine rotational speed 301 is less than a predetermined threshold,
the engine operating mode 303 corresponds to a guideline, i.e. the vehicle is, for example, in overrun conditions and
no external accesses 305 take place, such as, for example, by means of an engine-drag torque control, a traction control system, an electronic control program or a transmission protection device.

The calculation of the correction torque occurs on the basis of the engine rotational speed 301 and the coordinated correction torque, i.e. the desired torque 140. Preferably said calculation takes place with the aid of an engine characteristic map 320. A check is performed in an additional circuit unit 330 or in a corresponding program step to determine whether the correction value is less than a predetermined threshold, namely, for example, 40 Nm being present. The calculation of the correction value occurs only if this is the case along with the previously mentioned constraints. In order to avoid a negative influence on the driving behavior of the vehicle, the correction torque is added in a slope limiting manner with respect to its temporal curve and subsequently additively to a setpoint path in an adder or in step 350. The output torque 110 generated in this fashion is converted into an injection quantity 130 in the manner previously described. Too strong of an influence on the driving behavior is thereby also avoided by virtue of the fact that this correction is included in the calculation before the onset of driving comfort filters (not depicted), which are likewise implemented in the control unit 100.

The torque M is schematically plotted versus the time t in FIG. 2. The low-load range is denoted by a line, which represents the transition between overrun conditions and fraction conditions of the motor vehicle. The course 210 shows the driver's desired torque; a curve 220 represents the output torque after the partial fuel cut-off in the overrun previously described. FIG. 2 schematically depicts the mode of operation of such a partial fuel cut-off in the overrun. In the example of embodiment depicted in FIG. 2, a mixed data entry was thereby selected for the correction engine characteristic map. That means that the desired torque, which occurs in a phase denoted by the numeral I, is corrected to 0; and starting at a phase denoted by the numeral II, the desired torque is increased to such an extent that the critical torque range is faded out, i.e. is exceeded. The critical torque range varies, for example, between 0 and 40 Nm for a four cylinder 2.2 liter common rail diesel engine. This corresponds to the inner engine torque of such an engine. In Phase I, a correction value of −5 Nm is therefore, for example, imposed onto the driver specifications of 5 Nm, a correction value of −10 Nm onto the driver specifications of 10 Nm etc. so that 0 Nm results as the output torque. In Phase II, a correction torque of +20 Nm is imposed onto the driver specifications of 20 Nm and a correction torque of +10 Nm onto the driver specifications of 30 Nm so that a torque of 40 Nm or slightly larger than 40 Nm results. The torque is imposed as already previously mentioned in a slope limiting manner and subsequently in an additive manner. In so doing, the torque curve denoted in FIG. 2 with the reference numeral 210 arises. A critical range; which can occur at low-load operating points, whereat an oxygen restricted regeneration of the DPF is not assured, during a regeneration in the overrun; is avoided by such a torque curve. In so doing, a desired maximum limit temperature is not exceeded.

As stated earlier, the previously described method can be implemented as a computer program and can as such be stored on a computer program product. This has the advantage that the program can be “inputted” into existing controls, and in this way corresponding control units can be upgraded. This in turn also allows for diesel particle filters in vehicles to be upgraded although provision was not originally made in said filters for this purpose.

The invention is however not limited to the aforementioned examples. Purely as a matter of principle the method previously described—as stated—can also be implemented as a control circuit.

1. Method for operating a drive train of a vehicle comprising an internal combustion engine with an exhaust gas purification device located in the exhaust gas line, wherein in predetermined operating states of the internal combustion engine and/or of the vehicle a correction torque is imposed onto a desired torque produced by an engine control unit in relation to said desired torque such that an output torque is produced for a predetermined time interval, the value of said output torque lying outside a low-load range.

2. The method according to claim 1, wherein the predetermined operating states of the internal combustion engine and/or of the vehicle are characterized by the following conditions:
the engine rotational speed is less than a predetermined threshold,
a predetermined engine operating mode, in particular overrun conditions, prevails.

3. The method according to claim 2, wherein the predetermined operating states of the internal combustion engine and/or of the vehicle comprising the following additional conditions:
an external access of a control device, which controls the dynamics of vehicle movement, is not present—in particular an access of a traction control system, of an electronic control program, of an engine-drag torque control or of a transmission protection.

4. The method according to claim 1, wherein the determination of the correction torque occurs mathematically in a control unit on the basis of the engine rotational speed and the desired torque.

5. The method according to claim 1, wherein the determination of the correction torque occurs with the aid of an engine characteristic map, which represents the correlation between the correction torque and the engine rotational speed as well as the desired torque.

6. The method according to claim 1, wherein below a predetermined torque threshold the correction torque is adjusted such that the output torque corresponds to a value of 0 and in that above the predetermined torque threshold the correction torque is selected such that the output torque assumes a constant value, which is equal to or slightly larger than a predetermined torque value characterizing the low-load operating point.

7. The method according to claim 1, wherein the correction torque is added up in a slope limiting manner and subsequently added to the desired torque.

8. The method according to claim 1 wherein the correction torque is only then produced if the correction value is less than a predetermined threshold.

9. A device for carrying out a method according to claim 1, wherein provision is made for at least one engine control unit designed for carrying out the method.

10. Computer program, which executes all steps of a method according to claim 1 if it is run on a numeric field.

11. Computer program with program code, which is stored on a machine-readable carrier, for carrying out the method according to claim 1, wherein if the program is executed on a computer or in a control unit of an internal combustion engine.
